(19) United States
(12) Patent Application Publication
(10) Pub. No.: US 2006/0167763 A1
(43) Pub. Date: Jul. 27, 2006

(54) Service providing device and service providing method

(75) Inventor: Hiroki Mitsuhashi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited

(21) Appl. No.: 11/326,325

(22) Filed: Jan. 6, 2006

Related U.S. Application Data
(63) Continuation of application No. PCT/JP03/08610, filed on Jul. 7, 2003.

(51) Int. Cl. G06Q 30/00

(52) U.S. Cl. 705/26

(57) ABSTRACT

A service providing device, a service providing method, and a service providing program capable of releasing a functional limit of the service provided by a privilege of another service. When a first service based on the calculation is provided, information on the privilege obtained by using a second service is acquired. If this privilege information satisfies a predetermined condition, the functional limit of the first service is released.

### CROSS-REFERENCE TO RELATED APPLICATION

This is a continuation of Application PCT/JP2003/08610, filed on Jul. 7, 2003, now pending, the contents of which are herein wholly incorporated by reference.

### BACKGROUND OF THE INVENTION

The present invention relates to a service providing device, a service providing method and a service providing program for providing a service in a way that restricts part of a function or cancels the function restriction.

On the occasion of conducting a service such as providing a computer program through an ASP (Application Service Provider), the application service has hitherto been provided in a way that restricts a trial period, a trial count and a function (which will hereinafter be also referred to simply as function restriction).

For example, if a user applies for utilizing some of plural functions, the ASP issues a license key (password) to this user. Then, when the use makes a request for a service by using the license key, the program is provided by canceling the function restriction.

Further, there might be a case of providing the program by presetting the restriction on the trial count (an executable count). In this case, when the user installs the program into a computer and instructs the computer to execute the program, the computer, to begin with, judges by referring to executable count information whether the program can be executed or not, and, if executable, executes the program and decrements the executable count information by “1”.

Accordingly, the trial use can be kept up to the executable count, however, if over the executable count, the program can not be utilized till a normal license key is acquired by purchasing this program.

Moreover, such a system is proposed that if over the trial count, there is issued a key not making the program completely unusable but enabling, if the user desires to further utilize, the program to be utilized by a predetermined count (refer to Patent document 1).

Further, in a system that issues the license key online, there is also proposed a system for issuing, when getting very close to a trial time limit and if the time limit needs extending, a key for extending the time limit (refer to Patent document 2)

<Patent Document 1>

Japanese Patent Application Laid-Open Publication No. 2001-265585

<Patent Document 2>

Japanese Patent Application Laid-Open Publication No. 2001-312325

### SUMMARY OF THE INVENTION

As described above, in the case of canceling the function restriction, it was general to be liable for a cost.

Even when considering it necessary to cancel the function restriction and if unable to obtain an expected effect, a problem is that the cost gets futile.

Moreover, as in the system described above, if possible of extending the trial count and the trial period and if this extension is set liable for a cost, as compared with a case of purchasing the program without any extension after the trial use, it follows that an extra cost for the extension is required in the case of purchasing the program with the extension made after the trial use. Hence, there was a problem, wherein an impression of demerit is given to the user who made the extension.

The present invention was devised in view of the problems inherent in the priori arts. Namely, the present invention aims at enabling cancellation of function restriction of a to-be-provided service by use of special merits of other services. Hence, a trial use of the service can be performed without a user's making a new investment. Further, in the case of the service being purchased, the special merits can be effectively utilized by sending back at least part of special merit information employed for canceling the function restriction.

The present invention adopts the following means in order to solve the problems.

Namely, the present invention is a service providing device comprising:

a service providing module providing a first type service based on an arithmetic process;

a special merit management module acquiring special merit information from utilizing a second type service; and

a restriction canceling module canceling, when a function of the first type service is restricted and when the special merit management module acquires the special merit information usable for canceling this function restriction, at least part of the function restriction.

The service providing device may further comprise a purchase information input module accepting purchase information on the occasion of the first type service is purchased,

wherein the special merit management module, when accepting the purchase information, may send back at least part of the special merit information acquired for canceling the restriction.

In the service providing device, the service providing module, when providing the first type service, may restrict the function according to a restriction condition, and

the restriction canceling module may cancel the function restriction by updating the restriction condition.

In the service providing device, if a trial period and the special merit information necessary for canceling the function restriction are set as the restriction conditions, the service providing module may restrict the function on the occasion of providing the first type service after an elapse of the trial period, and the restriction canceling module, when the special merit management module acquires the special merit information necessary for canceling the function restriction, may update the restriction information so as to extend the trial period.

A service providing method of the present invention by which a computer executes the steps of, providing a first type service based on an arithmetic process, acquiring special merit information from utilizing a second type service, and canceling, when a function of the first type service is restricted and when acquiring the special merit information usable for canceling this function restriction in the special merit information acquiring step, at least part of the function restriction.

The service providing method may further comprise, accepting purchase information on the occasion of the first type service is purchased, and sending back, when accepting the purchase information, at least part of the special merit information acquired for canceling the restriction.

In the service providing method, when providing the first type service, the function may be restricted according to a restriction condition, and the function restriction canceling step may involve canceling the function restriction by updating the restriction condition.

In the service providing method, if a trial period and the special merit information necessary for canceling the function restriction are set as the restriction conditions, the function of the first type service may be restricted on the occasion of providing the first type service after an elapse of the trial period, and when acquiring the special merit information necessary for canceling the function restriction, the function restriction canceling step may involve updating the restriction information so as to extend the trial period.

Furthermore, the present invention may also be a program for making the computer execute the steps given above. Moreover, the present invention may also be a readable-by-computer recording medium recorded with such a program.

In the present invention, the first type service based on the arithmetic process is a service for providing a commercial object etc by processing of the computer, a connection service to the Internet, a distribution service of news and e-mails, and a service provided via the computer such as outputting (service) a result of the arithmetic result by the computer, etc. Moreover, the commercial object is an object usable by the computer such as a computer program and data of movies and music.

Further, in the present invention, the restriction condition includes information representing a restricted object such as the computer program and other functions, information such as a trial period and a trial count for judging whether the restriction is done or not, and information necessary for canceling the restriction.

### BRIEF DESCRIPTION OF THE DRAWINGS

FIG. 1 is a diagram showing a whole system including a service providing device of the present invention;

FIG. 2 is a diagram of a configuration of an ASP server 1;

FIGS. 3A-3C are explanatory diagrams of a first user database, a commercial object database and a second database;

FIG. 4 is a diagram of a configuration of a web server 2;

FIG. 5 is a diagram of a configuration of a user terminal 3;

FIG. 6 is an explanatory flowchart showing a procedure when logging in a first type service;

FIG. 7 is an explanatory flowchart showing a procedure of making a trial application; and

FIG. 8 is an explanatory flowchart showing a procedure of making a primary application.

### DETAILED DESCRIPTION OF THE PREFERRED EMBODIMENT

An embodiment of the present invention will hereinafter be described with reference to the drawings. It should be noted that a configuration in the following embodiment is an exemplification, and the present invention is not limited to the configuration in the embodiment.

§1. Whole Configuration

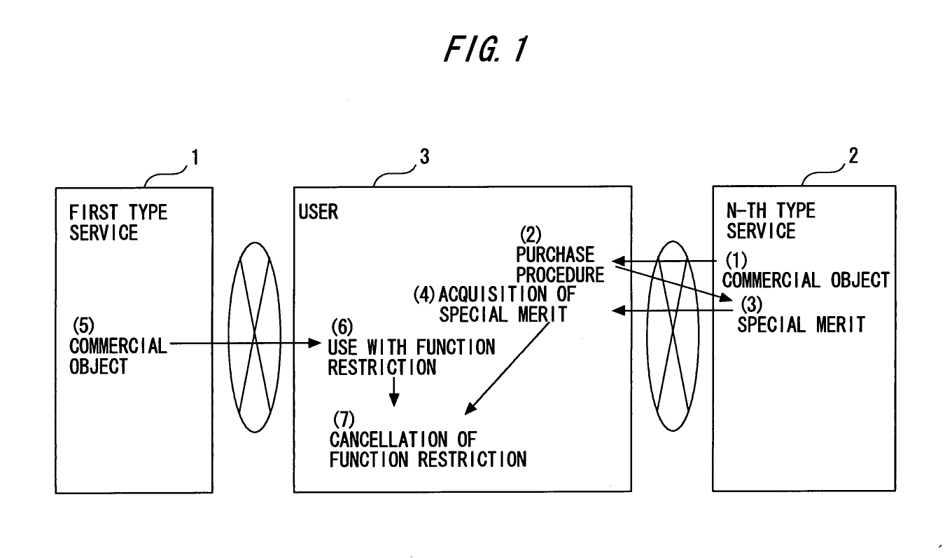

FIG. 1 is a diagram showing a whole system including a service providing device by way of one embodiment of the present invention.

In the present embodiment, an ASP server 1 for providing a first type service, a web server 2 for providing a second type service and a user terminal 3 utilizing the first and second type services, are connected to each other via a network such as the Internet and VPN (Virtual Private Network).

The web server 2 provides a sales service (the second type service) of commercial objects via the network. Further, the web server 2 issues a point (a special merit) corresponding to an amount of money of a purchase to a purchaser of the commercial object. Note that the web server 2 is illustrated as the single server for convenience, however, a plurality (including a plural types) of web servers 2 may exist.

The ASP server 1 performs a service (the first type service) for providing the user terminal 3 with application software (computer programs) for a CAD (Computer-Aided Design), a business system and so on.

The first type service, in which a function restriction is set, is provided in a way that cancels this function restriction in response to an application from a user. In the present embodiment, the function restriction of the first type service can be canceled by utilizing the point acquired by the second type service.

§2. Explanations of Respective Components

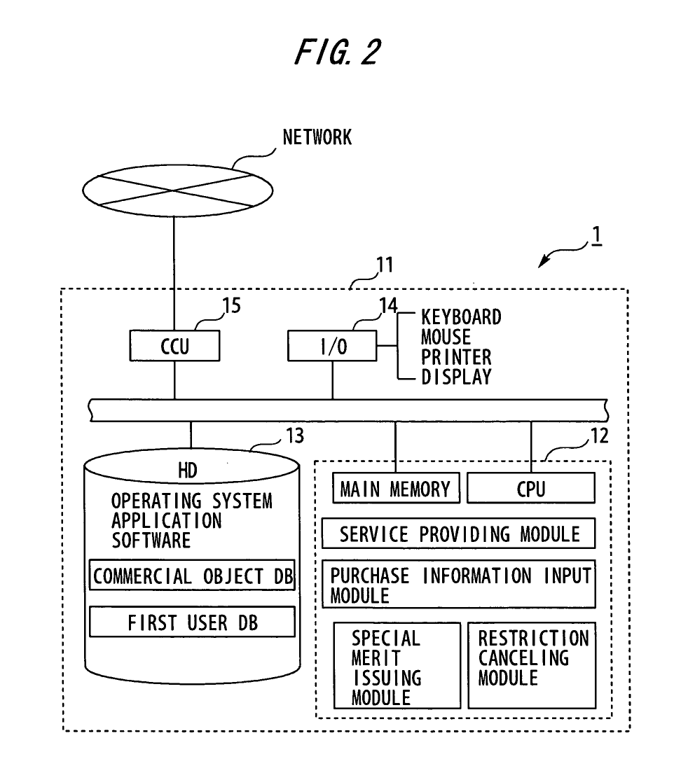

FIG. 2 is a diagram of a configuration of the ASP server 1.

The ASP server 1 is a so-called computer and includes, as illustrated in FIG. 2, within a main body 11, an arithmetic processing unit 12 constructed of a CPU (Central Processing Unit), a main memory, etc, a storage device (hard disc) 13 stored with data and software for an arithmetic process, an input/output (I/O) unit 14, a communication control unit (CCU) 15 and so on.

Connected properly to the I/O unit 14 are an input device such as a keyboard and a mouse, an output device such as a display device and a printer, and an interface for transmitting and receiving information to and from other devices.

The communication control unit 15 conducts control of communications with other computers via the network such as the Internet and the VPN.

The storage device 13 is preinstalled with an operating system (OS) and application software (a service providing program). Further, a commercial object database DB for the first type service and a first user database DB1 are built up within the storage device 13.

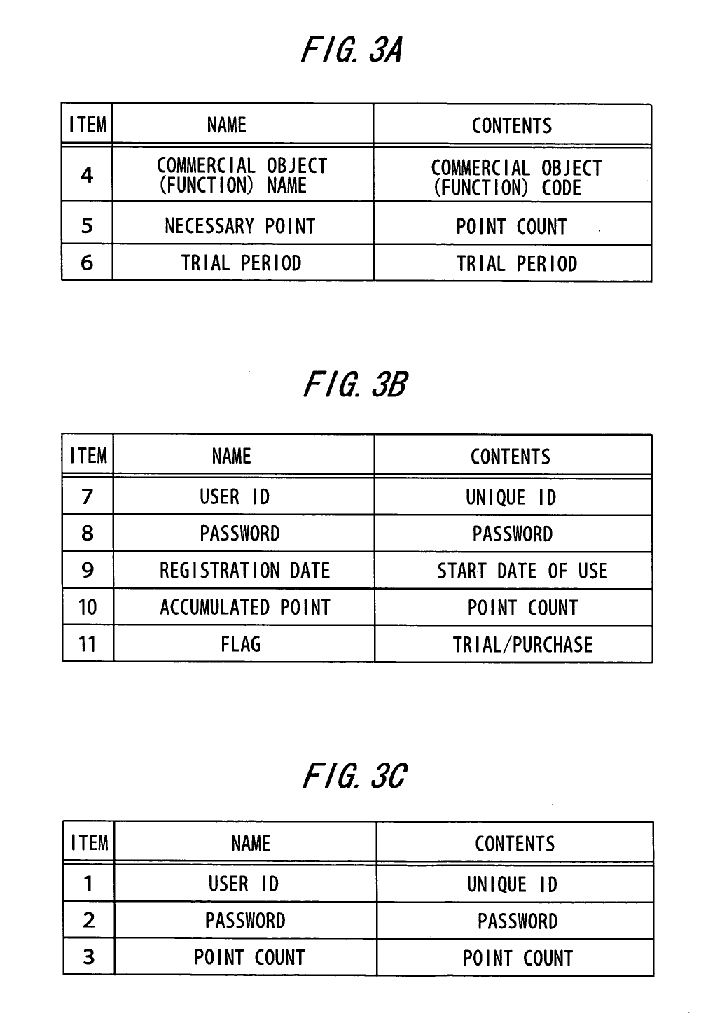

FIG. 3A is an explanatory table of the commercial object database DB for the first type service. The commercial object database DB is stored (registered) with, as shown in FIG. 3A, a commercial object (function) name such as a name and a code that specify a commercial object or a function, a necessary point defined as a special merit (which is a point count in this example) necessary of canceling the restriction on the commercial object or on the function, and a trial period representing a trial-enabled period in a way that associates these items with each other. Namely, the commercial object (function) name, the necessary point and the trial period correspond to restriction conditions in the present embodiment, wherein each commercial object (function) is so restricted as to enable the commercial object (function) to be executed within only the trial period, and this restriction is canceled in such a case that the necessary point is acquired.

Further, FIG. 3B is an explanatory table of the first user database DB1. The first user database DB1 is, as shown in FIG. 3B, stored (registered) with a user ID uniquely defined on a user-by-user basis, a password used for authentication together with the user ID, a registration date representing a date (registered date) when the use is started, an accumulated total point indicating a point count used for canceling the function restriction, and a flag showing whether or not there are an application for the purchase and an application for the trial (in this example, a flag setup status corresponds a case of having the application, and a flag non-setup status corresponds to a case of having no application) in a way that associates these items with each other.

The arithmetic processing unit 12 executes the arithmetic process according to the service providing program, thereby functioning as a service providing module, a special merit management module, a restriction canceling module and a purchase information input module.

The arithmetic processing unit 12, functioning as this service providing module, provides the user terminal with the first service based on the arithmetic process in a status of restricting part of function or canceling the function restriction.

The arithmetic processing unit 12, as the special merit management module, acquires information on the special merit obtained by using the second type service from the web server 2 (a second user database that will be explained later on).

The arithmetic processing unit 12, as the restriction canceling module, acquires from the special merit management module, if the function of the first type service is restricted, the special merit information usable for canceling this function restriction, and cancels at least part of the function restriction. In the present embodiment, the function restriction is canceled by updating the restriction conditions.

The arithmetic processing unit 12, as the purchase information input module, accepts the purchase information in the case of purchasing the first type service.

Further, the arithmetic processing unit 12, as the special merit management module, when accepting the purchase information, sends at least part of the special merit information acquired for canceling the restriction back to the web server 2.

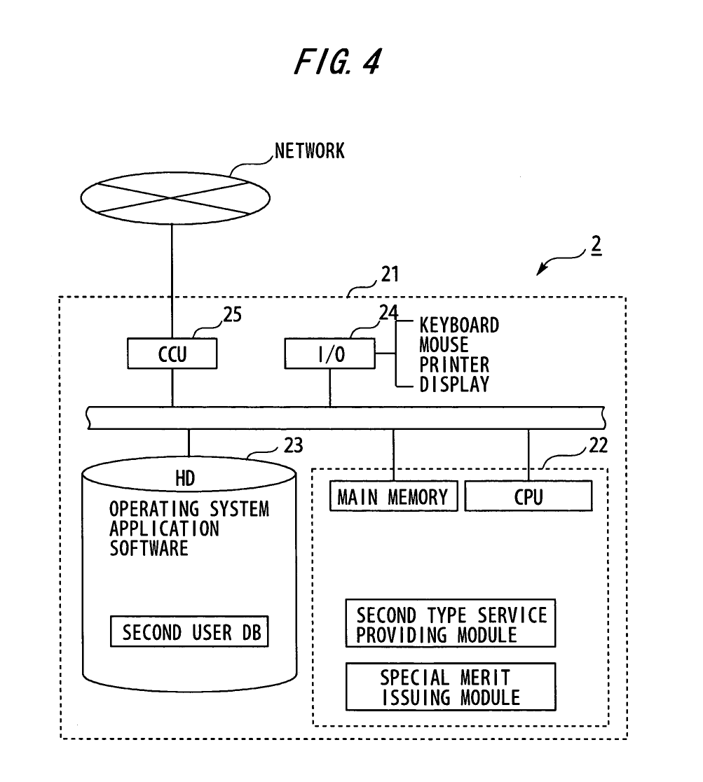

FIG. 4 is a diagram of a configuration of the web server 2.

The web server 2 is a so-called computer and includes, as illustrated in FIG. 4, within a main body 21, an arithmetic processing unit 22 constructed of a CPU (Central Processing Unit), a main memory, etc, a storage device (hard disc) 23 stored with data and software for the arithmetic process, an input/output (I/O) unit 24, a communication control unit (CCU) 25 and so on.

Connected properly to the I/O unit 24 are an input device such as a keyboard and a mouse, an output device such as a display device and a printer, and an interface for transmitting and receiving information to and from other devices.

The communication control unit 25 conducts control of communications with other computers via the network such as the Internet and the VPN.

The storage device 23 is preinstalled with an operating system (OS) and application software. Further, a second user database DB2 is built up within the storage device 23. FIG. 3C is an explanatory table of the second user database DB2. The second user database DB2 is, as shown in FIG. 3C, stored (registered) with a user ID uniquely defined on the user-by-user basis, a password used for authentication together with the user ID, and a point count showing a remaining number of the points issued to the user in a way that associates these items with each other.

The arithmetic processing unit 22 executes the arithmetic process according to the application software, thereby functioning as a second service providing module and a special merit issuing module.

The arithmetic processing unit 22, functioning as the second service providing module, provides the second type service, i.e., a commercial object sales service via the network. For example, the second service providing module provides the user terminal 3 as an access originator with a webpage containing a description of the commercial object and, when receiving a signal purporting a purchase of the commercial object, performs a sales procedure such as delivering the commercial object and indicating a demand for a cost. Note that this sales method may involve any type of known sales method such as a so-called shopping cart.

The arithmetic processing unit 22, as the special merit issuing module, issues a special merit corresponding to the service provided by the second service providing module, and stores information about this issued special merit on the second user database DB2 of the storage unit 23 on the user-by-user basis. Further, the special merit issuing module notifies the user or the user terminal 3 of this issued special merit and a quantity of the special merits accumulated on the user database. For instance, and a sales amount of the commercial object sold by the second service providing module is converted on the basis of 10 cents=1 point, wherein 100 points are issued when selling a commercial object priced at 10 dollars. This special merit may also be, without being limited to the points, coupons for a discount and upgrade (such as a right enabling the purchase at a discount price and a right enabling the upgrade free of charge).

Further, the web server 2 is provided separately from the ASP server (the service providing device) 1 and may also be configured integrally with the ASP server 1. Namely, the service providing device may take a configuration including at least some of the second type service providing module, the special merit issuing module and the user database.

Moreover, the second type service is not limited to the service via the network and may take, it is enough, a configuration in which the special merit issuing module of the ASP server (the service providing device) 1 can recognizes the special merit issued in the second type service. For instance, an adoptable configuration may be such that a person (a shop worker) at a real shop provides the second type service and issues the special merit, and the information on the issued special merit is stored on the ASP server (service providing device) 1, or alternatively the special merit management module of the ASP server (service providing device) 1 stores a connectable computer (corresponding to the web server 2) with the information on the issued special merit on.

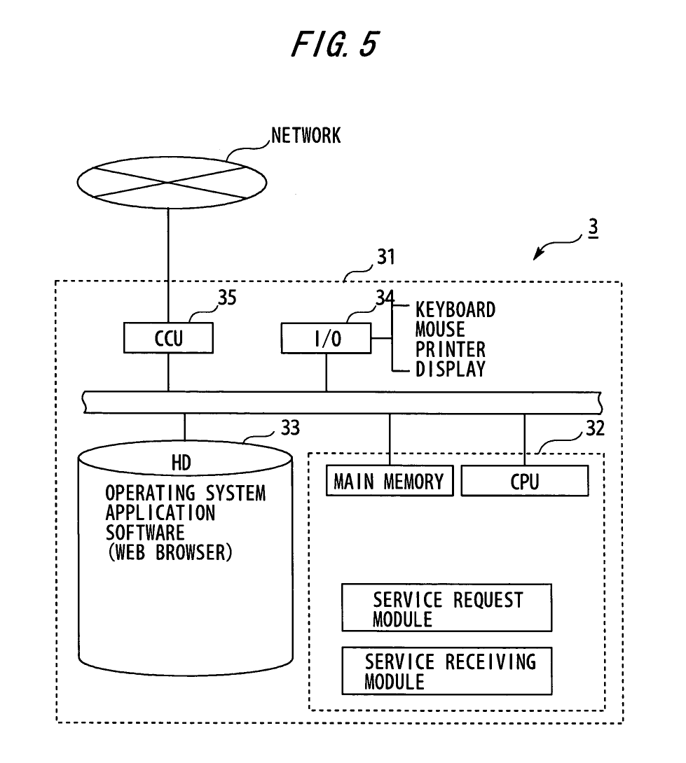

FIG. 5 is a diagram of a configuration of the user terminal 3.

The user terminal 3 is a so-called computer and includes, as illustrated in FIG. 5, within a main body 31, an arithmetic processing unit 32 constructed of a CPU (Central Processing Unit), a main memory, etc, a storage device (hard disc) 33 stored with data and software for the arithmetic process, an input/output (I/O) unit 34, a communication control unit (CCU) 35 and so on.

Connected properly to the I/O unit 34 are an input device such as a keyboard and a mouse, an output device such as a display device and a printer, and an interface for transmitting and receiving information to and from other devices.

The communication control unit 35 conducts control of communications with other computers via the network such as the Internet and the VPN.

The storage device 33 is preinstalled with an operating system (OS) and application software (a web browser etc).

The arithmetic processing unit 32 executes the arithmetic process according to the application software, thereby functioning as a service request module and a service receiving module.

The arithmetic processing unit 32, functioning as this service request module, transmits a signal with a purport of requesting the ASP server 1 and the web server 2 for the services. For example, the instruction signal is transmitted in a way that inputs an instruction content to an input box on a webpage (unillustrated) and clicks a transmission button.

The arithmetic processing unit 32, as the service receiving module, receives the services from the ASP server 1 and the web server 2 in response to the service request. For instance, the service receiving module receives the webpages, i.e., HTML-formatted files etc from the ASP server 1 and the web server 2, and displays the webpages on the display. Further, the user terminal 3 is capable of outputting the webpages from the printer and storing the webpages on the storage device 33.

In the present embodiment, the service request module and the service receiving module for utilizing the services are actualized by the so-called web browser, and may also take, without being limited to the web browser, configurations employing software for performing message communications, software for transferring the files, dedicated communication software, etc.

§3. Service Providing Method

3-1. Log-in Procedure

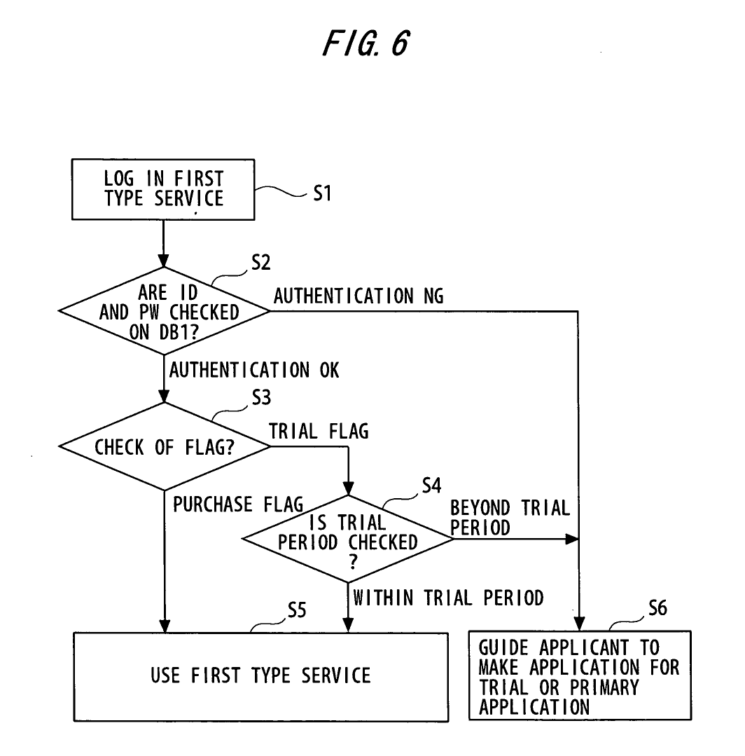

FIG. 6 is an explanatory flowchart showing a procedure on the occasion of logging in the first type service.

The ASP server 1, to begin with, when receiving the request for the first type service together with a user ID and a password PW from the user terminal 3 (step 1, which will hereinafter be abbreviated such as S1), refers to the user DB1 for the first type service, and authenticates the user ID and the password PW (S2).

If authenticated, the ASP server 1 refers to the user DB for the first type service, and checks a flag representing a distinction between the trial and the purchase (S3).

Hereat, if only a trial flag is set up, the ASP server 1 judges that an application for the trial is made, and judges by referring to the first user database DB1 whether within the trial period or not (S4). At this time, if within the trial period, the ASP server 1 starts providing the first type service.

Moreover, if a purchase flag is set up in step 3, the ASP server 1 provides the first type service without checking the trial period (S5).

Furthermore, if unable to authenticate in step 2 or if beyond the trial period in step 4, a webpage for prompting the user to make a trial application or a primary application is provided to the user terminal 3 (S6).

3-2 Trial Application

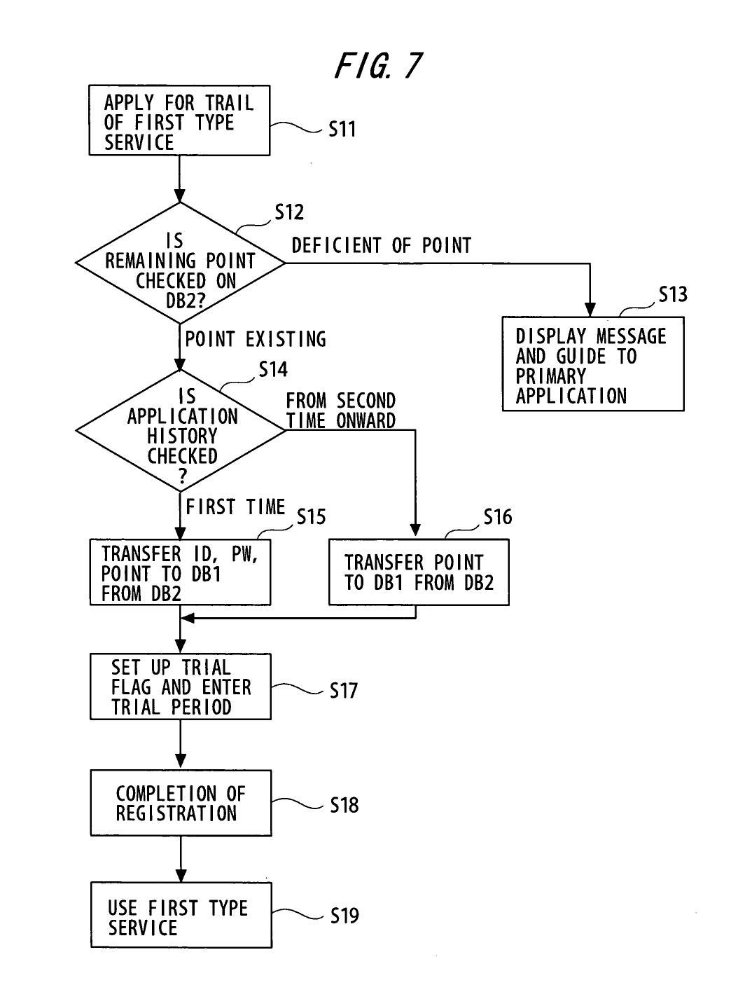

FIG. 7 is an explanatory flowchart showing a procedure of the trial application.

When receiving a signal requesting the trial application for the first type service together with the user ID and the password PW (S11) from the user terminal 3, the ASP server 1 accesses the web server 2, then refers to the second user database DB2, and checks whether or not an accumulated point count (remaining point count) is equal to or larger than a necessary point count on the commercial object database DB (S12).

Hereat, the ASP server 1, if the remaining point count is smaller than the necessary point count, provides the user terminal 3 with the webpage prompting the user to make the primary application (S13) and, if the remaining point count is equal to or larger than the necessary point count, checks an application history (S14). This application history is checked by judging whether or not this user ID has already been stored on the user database DB for the first type service.

If the trial application is made for the first time, the ASP server 1, through the function of the special merit issuing module, acquires the special merit information usable for canceling the function restriction, and stores this special merit information, the user ID and the password on the first user database DB1. To be specific, the ASP server 1 reads a point count necessary for the trial by referring to the commercial object database DB3, and requests the web server 2 for this necessary point count. Then, when receiving the necessary points from the web server 2, the ASP server 1 stores afresh the first user database DB1 with the necessary points in a way that associates the points with the user ID and the password PW (S15).

Further, if the trial application is made from the second time onward, the ASP server 1 similarly acquires the special merit information and stores this special merit information on the first user database DB1. IN this from-the-second-time-onward case, the user ID has already been stored, and hence the point count utilized for the trial of the first type service is to be integrated by adding the necessary points of this time to the points so stored as to be associated with the user ID (S16).

After acquiring this special merit information, the ASP server 1, through the function of the restriction canceling module, sets up the trial flag on the first user database DB1, and inputs the trial period. Namely, the ASP server 1 updates restriction information (S17). For example, this trial period is set so that the trial is kept usable for a predetermined period since the application date. Accordingly, if the predetermined period is 10 days and the application date is April 20, April 30 (the trial period) is inputted, whereby the trial is kept usable till this date. Furthermore, on the occasion of acquiring the points in steps 15 and 16, an input of the point count to be utilized is obtained, and the trial period may be set corresponding to the point count inputted by the user. For instance, the trial period maybe set on such a basis that one day is given for every 10 points, wherein the trial period is 10 days if 100 points are inputted and is 20 days if 200 points are inputted.

Then, the ASP server 1 completes the registration of the trial (S18) and, through the function of the service providing module, starts providing the first type service (S19).

3-3 Primary Application

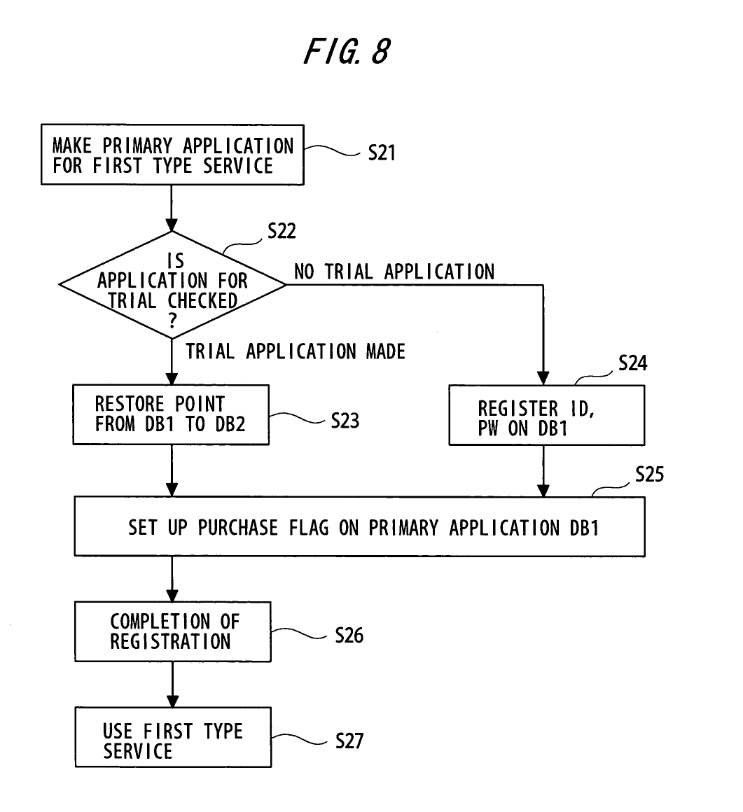

FIG. 8 is an explanatory flowchart showing a procedure of the primary application.

The ASP server 1, through the function of the purchase information input module, when receiving a signal that requests the primary application for the first type service together with the user ID and the password PW from the user terminal 3 (S21), starts a procedure of the primary application in FIG. 8. The ASP server 1, at first, refers to the first user database DB1 and thus judges whether the trial application is made or not, i.e., whether or not the trial flag associated with the user ID is set up (S22).

If the trial application is made, the ASP server 1, through the function of the special merit management module, obtains the point count utilized for the trial by referring to the first user database DB1, and sends this point information (back) to the web server 2, i.e., restores the points to the user (to the second user database of the web server 2), whereby the points can be utilized for other services etc (S23).

Moreover, when judging in step S22 that the trial application is not made, the ASP server 1 registers the user ID and the password PW on the first user database (S24).

Thereafter, the ASP server 1 sets up the purchase flag on the first user database DB1 (S25), then completes the registration of the primary application (S26) and starts providing the first type service (S27).

As described above, according to the present embodiment, the function restriction on the first type service can be canceled owing to the special merit of the second type service. Accordingly, the user can make the trial use of the service without doing a new investment and can, after confirming that an expected effect is to be acquired, purchase the service. Further, in the case of purchasing the service, the special merit can be utilized for other services (such as purchasing the commercial objects from the web server 2) by sending back the special merit information used for canceling the function restriction, thus enabling the special merits to be effectively utilized.

§4. Modified Example

In the embodiment discussed above, the trial period is set and extended by acquiring the special merit information, however, the present invention is not limited to this scheme.

For example, a trial count (a possible-of-trial count) is set as a restriction condition on the commercial object database DB, wherein when the user logs in, the ASP server 1 checks in step 4 (FIG. 6) whether this trial count is “0” or not. Hereat, the ASP server 1, if the trial count is larger than “0”, starts providing the first type service (S5), and decrements this trial count by “1”. Moreover, the ASP server 1, if the trial counts is “0”, provides the user terminal 3 with a webpage prompting the user to make the trail application or the primary application (S6).

In this case, the ASP server 1, on the occasion of accepting the trial application and executing the steps in FIG. 7, after acquiring the special merit information, sets up the trial flag on the first user database DB1, and inputs the trial count (S17). Note that other configurations are substantially the same as those in the embodiment discussed above.

Further, the special merit may be, without being limited to the point, a coupon etc for a discount and upgrade. For instance, the coupons are stored as a substitute for the necessary points on the commercial object database DB so that in the case of a 10% discount coupon, the trial count is incremented by 10, and, in the case of an upgrade coupon, the trial count is incremented by 20. Then, the ASP server 1, in the case of acquiring the coupon in steps 15 and 16 when making the trial application, refers to the commercial object database and inputs this coupon so that the trial count is incremented by 10 or 20 in step 17.

Furthermore, in the case of the first type service being purchased, the ASP server 1 sends this special merit information back to the web server 2. Through this operation, the user can receive the discount on the occasion of purchasing the commercial object from the web server 2 and receives the upgrade of the purchased commercial object by use of the special merit (coupon), thus enabling the special merit to be effectively utilized.

Moreover, the special merit information needed for canceling the function restriction may be, without being limited to the fixed value, changed each time the trial application is made. For instance, the necessary point count is set to “0” (i.e., the function restriction is canceled by omitting the acquisition of the special merit information) if being the first trial application, and is set equal to or larger than “1” if being the application from the second time onward.

Thus, the same effects as those in the embodiment discussed above are obtained from the configuration of the present modified example.

§5. Readable-by-Computer Recording Medium

The service providing program is recorded on a recording medium and may thus be provided. This recording medium, from which the computer is made to read and execute the program, thereby enables the functions thereof to be actualized and the services to be provided.

Herein, the recording medium readable by the computer connotes a recording medium capable of storing information such as data and programs electrically, magnetically, optically, mechanically or by chemical action, which can be read from the computer. Among these recording mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc. are given as the recording mediums fixed within the computer.

As discussed above, according to the present invention, the function restriction of the service to be provided can be canceled owing to the special merits given from other services. Accordingly, the user can make the trial use of the service without doing the new investment. Furthermore, in the case of the service being purchased, the special merits can be utilized by sending back at least part of the special merit information used for canceling the function restriction.

What is claimed is:

1. A service providing device comprising:
a service providing module providing a first type service based on an arithmetic process;
a special merit management module acquiring special merit information from utilizing a second type service; and
a restriction canceling module canceling, when a function of said first type service is restricted and when said special merit management module acquires the special merit information usable for canceling this function restriction, at least part of the function restriction.

2. A service providing device according to claim 1, further comprising a purchase information input module accepting purchase information on the occasion of said first type service is purchased,
wherein said special merit management module, when accepting the purchase information, sends back at least part of the special merit information acquired for canceling the restriction.

3. A service providing device according to claim 1, wherein said service providing module, when providing said first type service, restricts the function according to a restriction condition, and
said restriction canceling module cancels the function restriction by updating the restriction condition.

4. A service providing device according to claim 3, wherein if a trial period and the special merit information necessary for canceling the function restriction are set as the restriction conditions, said service providing module restricts the function on the occasion of providing said first type service after an elapse of the trial period, and
said restriction canceling module, when said special merit management module acquires the special merit information necessary for canceling the function restriction, updates the restriction information so as to extend the trial period.

5. A service providing method by which a computer executes the steps of:
providing a first type service based on an arithmetic process;
acquiring special merit information from utilizing a second type service; and
canceling, when a function of said first type service is restricted and when acquiring the special merit information usable for canceling this function restriction in said special merit information acquiring step, at least part of the function restriction.

6. A service providing method according to claim 5, further comprising:
accepting purchase information on the occasion of said first type service is purchased; and
sending back, when accepting the purchase information, at least part of the special merit information acquired for canceling the restriction.

7. A service providing method according to claim 5, wherein when providing said first type service, the function is restricted according to a restriction condition, and
said function restriction canceling step involves canceling the function restriction by updating the restriction condition.

8. A service providing method according to claim 7, wherein if a trial period and the special merit information necessary for canceling the function restriction are set as the restriction conditions, the function of said first type service is restricted on the occasion of providing said first type service after an elapse of the trial period, and
when acquiring the special merit information necessary for canceling the function restriction, said function restriction canceling step involves updating the restriction information so as to extend the trial period.

9. A recording medium recorded with a service providing program for making a computer execute the steps of:
providing a first type service based on an arithmetic process;
acquiring special merit information from utilizing a second type service; and
canceling, when a function of said first type service is restricted and when acquiring the special merit information usable for canceling this function restriction in said special merit information acquiring step, at least part of the function restriction.
